(19) United States
(12) Patent Application Publication
(10) Pub. No.: US 2025/0348674 A1
(43) Pub. Date: Nov. 13, 2025

(54) DISTRIBUTING PROMPT PROCESSING IN GENERATIVE ARTIFICIAL INTELLIGENCE MODELS

(71) Applicant: QUALCOMM Incorporated, San Diego, CA (US)

(72) Inventors: Shubhankar Mangesh BORSE, San Diego, CA (US); Shreya KADAMBI, San Diego, CA (US); Munawar HAYAT, San Diego, CA (US); Fatih Murat PORIKLI, San Diego, CA (US)

(21) Appl. No.: 18/657,472

(22) Filed: May 7, 2024

(51) Int. Cl. G06F 40/284; G06T 11/00

(52) U.S. Cl. CPC G06F 40/284; G06T 11/00; G06T 2211/441

(57) ABSTRACT

Certain aspects of the present disclosure provide techniques and apparatus for generating responses to large input prompts using a generative artificial intelligence model. An example method generally includes receiving an input prompt for processing using a generative artificial intelligence model. The input prompt is partitioned into a plurality of sub-prompts based on contextual information associated with tokens in the input prompt. A response to the input prompt is generated using the generative artificial intelligence model based on the plurality of sub-prompts and the contextual information associated with the tokens in the input prompt. The generated response is output.

### INTRODUCTION

Aspects of the present disclosure relate to generative artificial intelligence models.

Generative artificial intelligence models can be used in various environments in order to generate a response to an input prompt (also referred to as a query or an input). For example, generative artificial intelligence models can be used in chatbot applications in which large language models (LLMs) are used to generate an answer, or at least a response, to an input prompt. Other examples in which generative artificial intelligence models can be used include a latent diffusion model, in which a model generates an image or stream of images (e.g., video content) from an input text description of the content of the desired image or stream of images, decision transformers, in which future actions are predicted based on sequences of prior actions within a given environment, or the like. These models may be used, for example, autonomous driving, image capture, and image display applications (e.g., extended reality, augmented reality, and/or virtual reality applications) to generate image outputs used within these applications.

### BRIEF SUMMARY

Certain aspects of the present disclosure provide a method for generating responses to large input prompts using a generative artificial intelligence model. The method generally includes receiving an input prompt for processing using the generative artificial intelligence model. The input prompt is partitioned into a plurality of sub-prompts based on contextual information associated with tokens in the input prompt. A response to the input prompt is generated using the generative artificial intelligence model based on the plurality of sub-prompts and the contextual information associated with the tokens in the input prompt. The generated response is output.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict only certain aspects of this disclosure and are therefore not to be considered limiting of the scope of this disclosure.

FIG. 1 illustrates a generative artificial intelligence model configured to generate an output in response to a large input prompt using a gating mechanism that partitions the large input prompt into a plurality of sub-parts, according to aspects of the present disclosure.

FIG. 2 illustrates an example gating mechanism for partitioning a large input prompt into one or more sub-prompts, according to aspects of the present disclosure.

FIG. 3 illustrates example operations for generating an output in response to a large input prompt using a generative artificial intelligence model including a gating mechanism that partitions the input prompt into a plurality of sub-parts, according to aspects of the present disclosure.

FIG. 4 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatus, methods, processing systems, and computer-readable mediums for distributing the processing of large input prompts in generative artificial intelligence models to accurately generate an output reflecting the input prompt.

Generally, generative artificial intelligence models generate a response to a prompt input into the model. For example, generative artificial intelligence models can generate images or other visual content depicting one or more objects specified in an input prompt provided to the generative artificial intelligence model. While generative artificial intelligence models can generate visual content, generative artificial intelligence models may not accurately generate visual content including the requested content in the input prompt. For example, generative artificial intelligence models may tokenize an input prompt into a predefined number of tokens which can be used by the generative artificial intelligence models to generate the output requested by the prompt. While the use of the predefined number of tokens to represent a query may allow for generative artificial intelligence models to generate an output that accurately reflects what was requested in small prompts (e.g., prompts that do not include a large number of objects to render or conditions for rendering), the use of the predefined number of tokens to represent a query may not result in an accurate output for larger prompts. Such degradation may occur, for example, because the entirety of the prompt is processed in each layer of the generative artificial intelligence model and in the same manner during each iteration of processing the prompt through the generative artificial intelligence model.

A large input prompt may request that a generative artificial intelligence model generate, for example, an image or other visual content including a variety of objects and apply a variety of transformations to the visual content. Generally, objects in the generated image may be local concepts. For example, some objects may be located in the foreground of an image, while other objects may be located in the background of the image. Objects may also have spatial relationships with each other which may be specified in the input prompt. In contrast, modifiers specified in the input prompt may be local or global concepts. Some modifiers may apply to specific objects or specific portions of an image (e.g., foreground content, background content, etc.), while other modifiers may be global concepts that apply to the generated image as a whole. Thus, processing the tokens in the large input prompt in the same manner regardless of whether the tokens are associated with local or global concepts or specific timing relationships may cause the outputs generated by generative output models to be inaccurate vis-à-vis the input prompt.

Aspects of the present disclosure provide techniques and apparatus for accurately generating responses to large input prompts by generative artificial intelligence models. To do so, aspects of the present disclosure decompose a prompt into a plurality of sub-prompts which may be processed independently. These sub-prompts may, for example, include tokens which are logically related to each other (e.g., according to contextual information associated with these tokens) so that the generative artificial intelligence model can process these sub-prompts independently (e.g., using different layers of the generative artificial intelligence model, at different times, etc.). By doing so, aspects of the present disclosure may allow for generative artificial intelligence models to accurately generate outputs that reflect what is specified in the input prompt even as the size and complexity of the input prompt increases.

### Example Large Input Prompt Processing Using Generative Artificial Intelligence Models

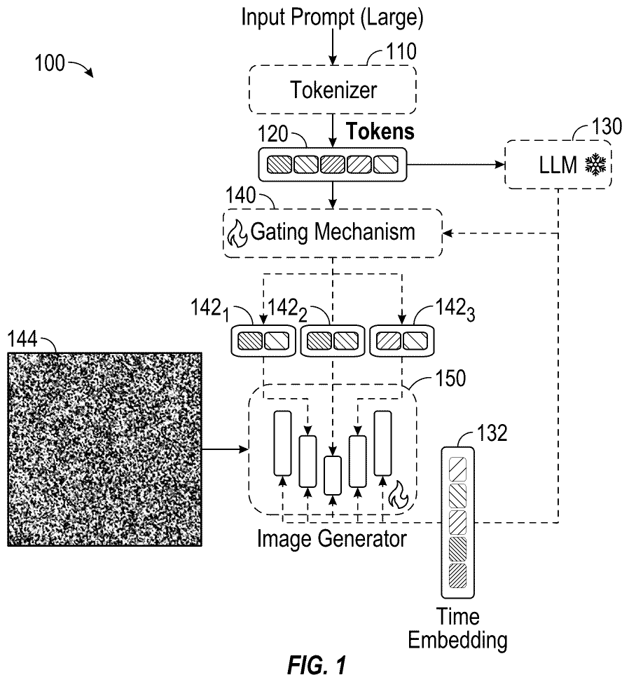

FIG. 1 illustrates a generative artificial intelligence model 100 that generates responses to a large input prompt using a gating mechanism that partitions the large input prompt into a plurality of sub-parts, according to aspects of the present disclosure. Generally, as discussed, a large input prompt may be an input prompt into a generative artificial intelligence model that specifies an output to be generated according to one or more conditions applicable and one or more objects to be included in the output. As illustrated, the generative artificial intelligence model includes a tokenizer 110, a large language model 130, a gating mechanism 140, and an image generator 150.

To generate an image from a large input prompt, which is generally a text string specifying the content of an output generated by the generative artificial intelligence model 100, the tokenizer 110 generates a set of tokens 120 representing the large input prompt. The set of tokens 120 may be a one-dimensional array including a plurality of tokens derived from the large input prompt. In some aspects, tokens in the set of tokens 120 may represent words or portions of words in the large input prompt. Within the one-dimensional array, the ordering of tokens may reflect the ordering of words in the large input prompt, such that a correlation may exist between tokens in the set of tokens 120 and words or portions of words in the input prompt.

The set of tokens may be provided as input into the large language model 130, which may be an a priori trained model and may be frozen, and the gating mechanism 140, which may be a learnable machine learning model that adapts to data processed by the generative artificial intelligence model 100, in order to partition the large input prompt into a plurality of sub-prompts 142₁, 142₂, and 143₃ (amongst others, collectively referred to as “sub-prompts 142”). In some aspects, the gating mechanism 140 may be configured to generate the sub-prompts 142 based on a time embedding 132 or other temporal contextual information identifying a portion of the image generating process which is ongoing in the generative artificial intelligence model 100. By doing so, the gating mechanism 140 can generate sub-prompts 142 that are relevant to generating different objects in the image at each stage of the image generation process. Generally, these different stages may correspond, for example, to different layers of the model implemented by the image generator 150 and may correspond to different resolutions or receptive fields in an image generated by the image generator 150.

In some aspects, partitioning the large input prompt represented by the set of tokens 120 may additionally or alternatively be generated by the gating mechanism based on the output of a large language model 130 trained to generate contextual information about the tokens in the set of tokens which can be used as input by the gating mechanism. In some aspects, the large language model 130 can generate contextual information for each token in the set of tokens.

The contextual information may, for example, be spatial contextual information identifying an area of the output to be generated by the image generator 150 in which an object represented by a token is to be located, temporal contextual information identifying temporal dependencies associated with different objects included in the output generated by the image generator 150, and the like. Spatial contextual information may, for example, indicate whether a token is associated with a local concept or a global concept and thus an area of a latent image (e.g., an image from a previous round of inferencing generated by the generative artificial intelligence model 100) to be modified by the image generator 150. Generally, local concepts correspond to objects which involve processing in a portion of the image output generated by the image generator 150 and may have varying degrees of granularity. For example, local concepts may be organized into foreground and background content. In another example, local concepts may be organized into different spatial areas with relationships to other spatial areas in the image output generated by the image generator 150. Global concepts correspond to objects or modifications which involve processing the image output in its entirety. For example, global concepts may include a style to be applied by the image generator 150 to the image output in its entirety, simulations of photographic filters on the image output, or the like.

Temporal contextual information identified by the large language model 130 may include information identifying a temporal stage in the inferencing processing at which the image generator 150 is to process tokens in the set of tokens 120. Generally, tokens relating to objects that do not have spatial relationships to other objects specified in the input prompt may be associated with temporal contextual information identifying that these tokens can be processed earlier in the inferencing process than other tokens. Tokens relating to objects that do have spatial relationships to other objects specified in the input prompt may be associated with temporal contextual information identifying the objects which the image generator 150 are to generate prior to processing these tokens. Finally, tokens relating to globally applicable changes to the image generated by the image generator 150 may be associated with temporal contextual information identifying that these tokens are to be processed at the end of the inferencing process.

The contextual information generated by the large language model 130 may be provided as input into the gating mechanism 140, which as illustrated, decomposes the set of tokens 120 representing the input prompt into a plurality of sub-prompts 142 including subsets of the set of tokens 120. Generally, the gating mechanism 140 decomposes the set of tokens 120 into the plurality of sub-prompts 142 based on the contextual information identified by the large language model 130 for the tokens in the set of tokens 120. In some aspects in which the large language model 130 generates spatial contextual information, the gating mechanism 140 can generate sub-prompts 142 based on shared spatial information for tokens in the set of tokens 120 representing the input prompt. For example, the gating mechanism 140 can generate sub-prompts 142 for tokens associated with local concepts and tokens associated with global concepts. In another example, the gating mechanism 140 can generate sub-prompts 142 for tokens associated with foreground content and tokens associated with background content. In some aspects in which the large language model 130 generates temporal contextual information, the gating mechanism 140 can generate sub-prompts 142 based on a stage in the inferencing process at which different objects are to be generated or different modifications are to be applied to the image.

The sub-prompts 142 may be input into the image generator 150, along with a Gaussian noise image 144 and a time embedding 132, for use in generating an image output of the generative artificial intelligence model 100. The image generator 150 may be, for example, a generative artificial intelligence model, such as a text-to-image diffusion model (e.g., a U-Net model), including a plurality of layers. Different layers in the image generator 150 may be used to generate content in different spatial areas of the image, starting with the Gaussian noise image 144 and progressively denoising the image to result in an image including the objects specified in the input prompt and in the style specified in the input prompt.

In some aspects, the sub-prompts 142 may be routed to and processed by different layers in the image generator 150. Generally, the processing of the sub-prompts 142 by different layers in the image generator 150 allows for different portions of the image output generated by the image generator 150 to be processed according to the time embedding 132, which identifies a step in the inferencing process (e.g., a diffusion step in which the image generator 150 denoises a latent image to generate an image including the objects and effects specified in the input prompt) in which the image is being processed, and the area to be affected by processing the tokens included in the sub-prompts 142.

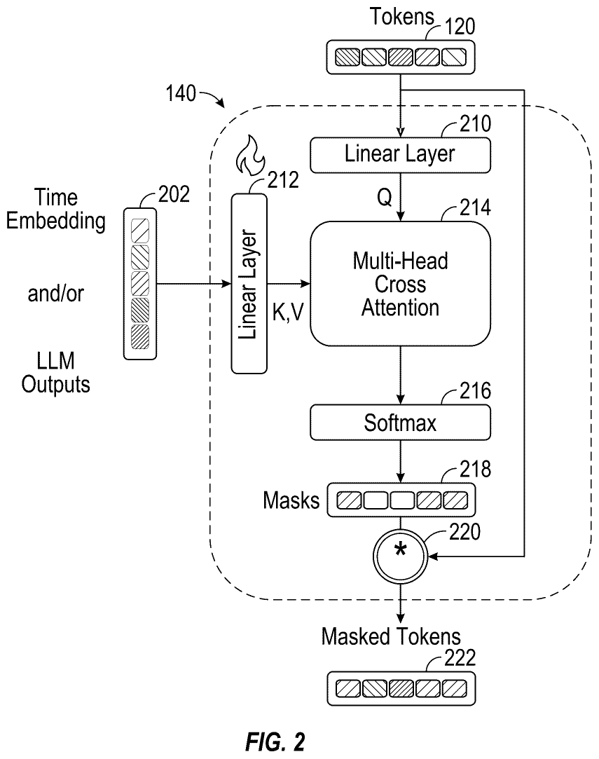

FIG. 2 illustrates the architecture of the gating mechanism 140 which, as discussed above, partitions a large input prompt into one more sub-prompts, according to aspects of the present disclosure.

As illustrated, the gating mechanism 140 may be an attention-based neural network which generates sub-prompts as a set of masked tokens 222 from a set of tokens 120 representing a tokenized version of the large input prompt provided as input into the generative artificial intelligence model 100 illustrated in FIG. 1. As illustrated, includes a first layer 210 (also referred to as a first projection layer) configured to project the set of tokens 120 into query data and a second layer 212 (also referred to as a second projection layer) configured to project the contextual information associated with the inferencing process and/or the set of tokens 120 into key and value data. As discussed above, the contextual information may include spatial contextual information identifying portions of the image generated by the generative artificial intelligence model 100 which are affected by different tokens in the set of tokens 120 representing the large input prompt and/or temporal contextual information identifying an inferencing stage currently being executed by the generative artificial intelligence model 100 or temporal relationships between different objects or affects specified in the large input prompt.

The query data generated by the first layer 210 and the key and value data generated by the second layer may be fed into an attention block 214 for processing. The attention block 214 generally uses query data generated from the set of tokens 120 and the key and value data generated from the contextual data 202 to determine which tokens are relevant to a specific inferencing round or portion of an image being processed by the generative artificial intelligence model 100. The output of the attention block 214 may be a probability value associated with each token in the set of tokens 120 identifying a likelihood of those tokens being relevant to a specific inferencing round or portion of an image being processed by the generative artificial intelligence model 100. The probability values for each token may be processed by a nonlinear layer 216 (e.g., illustrated as a softmax layer, though the use of other nonlinear functions in the nonlinear layer 216 may also be contemplated; for example, the nonlinear layer 216 may alternatively be a sigmoid layer) to generate one or more masks 218 to apply to the set of tokens 120 to generate sub-prompts for processing. The masks 218 may be combined with the set of tokens 120 (e.g., via a multiplication block 220) to generate a set of masked tokens 222. In some aspects, the sum of the values identified in a mask 218 may be 1, with relevant tokens being associated with higher values and non-relevant tokens being associated with zero or near-zero values. By combining a mask 218 with the set of tokens 120 using the multiplication block 220, the resulting masked tokens 222 may include a plurality of zero or near-zero values for tokens that are not relevant to a specific sub-prompt (e.g., portion of an input prompt being processed during a given inferencing round in the generative artificial intelligence model 100) and non-zero values for tokens that are relevant to a specific sub-prompt. In some aspects, the nonlinear layer 216 may include a rounding function which converts probability values above a threshold level (which may be defined a priori) to values of one and probability values below the threshold level to zero so that the resulting masked tokens 222 generated by multiplying the set of tokens 120 by the mask 218 includes in either zero-valued tokens or a token with an identical value to the corresponding token in the set of tokens 120.

### Example Operations for Processing Large Input Prompts Using Generative Artificial Intelligence Models

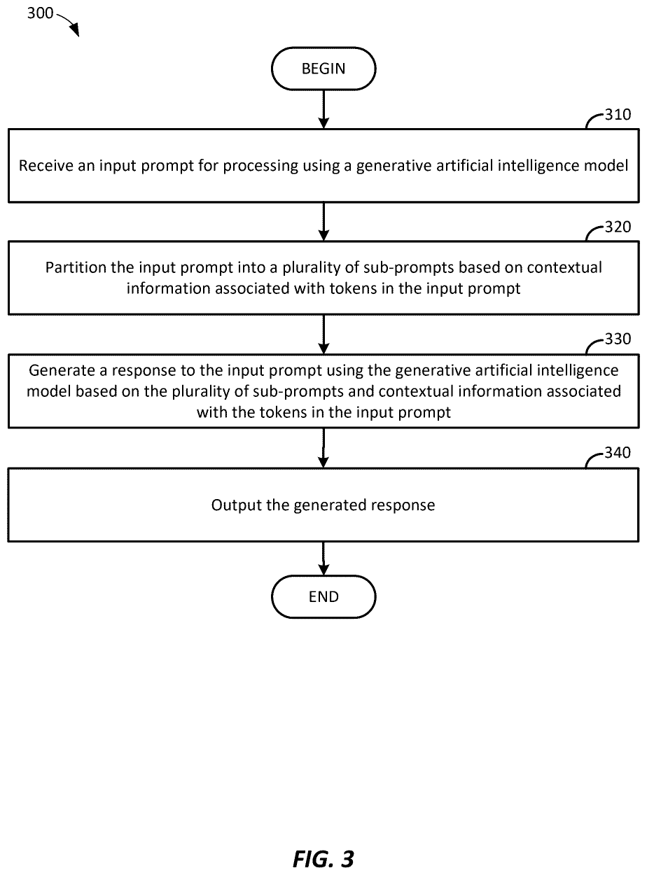

FIG. 3 illustrates example operations 300 for generating an output to a large input prompt using a generative artificial intelligence model including a gating mechanism that partitions the input prompt into a plurality of sub-parts, according to aspects of the present disclosure. The operations 300 may be performed by a device on which a generative artificial intelligence model can be deployed, such as a smartphone, a tablet computer, a laptop computer, a desktop, a server, a cloud compute instance hosted in a distributed computing environment, or the like.

As illustrated, the operations 300 begin at block 310 with receiving an input prompt for processing using a generative artificial intelligence model.

At block 320, the operations 300 proceed with partitioning the input prompt into a plurality of sub-prompts based on contextual information associated with tokens in the input prompt.

In some aspects, the contextual information includes breadth metrics associated with the tokens in the input prompt. To partition the input, a respective breadth metric may be associated with a respective token from the tokens in the input prompt using a language model. The tokens in the input prompt may be partitioned based on respective breadth metrics associated with respective tokens from the tokens in the input prompt. In some aspects, the respective breadth metric comprises an indication of whether the respective token corresponds to a global concept in the input prompt or one or more local concepts in the input prompt. The tokens in the input prompt may be partitioned into a set of tokens corresponding to the global concept and one or more sets of tokens corresponding to the one or more local concepts in the input prompt.

In some aspects, the breadth metrics may corresponding to spatial contextual information discussed above. Local concepts may be, for example, concepts in which a portion of an image that is less than the entirety of the image is to be modified by processing the associated tokens in the generative artificial intelligence model. Global concepts may be, in contrast, concepts involving the modification of the entirety of the image.

In some aspects, the contextual information may include temporal embeddings associated with the tokens in the input prompt. The input prompt may be partitioned into the plurality of sub-prompts by partitioning the tokens in the input prompt into groups of temporally related tokens based on the temporal embeddings.

In some aspects, the contextual information may include temporal embeddings associated with the output generation process. Generally, these temporal embeddings may correspond to a step in the output generation process which is currently being executed.

At block 330, the operations 300 proceed with generating a response to the input prompt using the generative artificial intelligence model based on the plurality of sub-prompts and the contextual information associated with the tokens in the input prompt.

In some aspects, the generative artificial intelligence model includes a gating mechanism configured to route the plurality of sub-prompts to different layers of the generative artificial intelligence model based on the contextual information associated with the tokens in the input prompt. The gating mechanism may be, for example, an attention layer or other attention-based neural network. The gating mechanism generally includes a first projection block that projects the contextual information to key and value data; a second projection block that projects the tokens in the input prompt to query data; a multi-head attention block that generates an attention output based on the key data, the value data, and the query data; and a nonlinear projection layer that generates an attention mask based on the attention output, the attention mask being combined with the tokens in the input prompt to generate a masked set of tokens as an output of the gating mechanism.

In some aspects, the generative artificial intelligence model comprises a text-to-image diffusion model configured to generate an image output from a textual input.

At block 340, the operations 300 proceed with outputting the generated response.

In some aspects, the generated response may be an image depicting one or more objects specified by the input prompt.

### Example Processing Systems for Processing Large Input Prompts Using Generative Artificial Intelligence Models

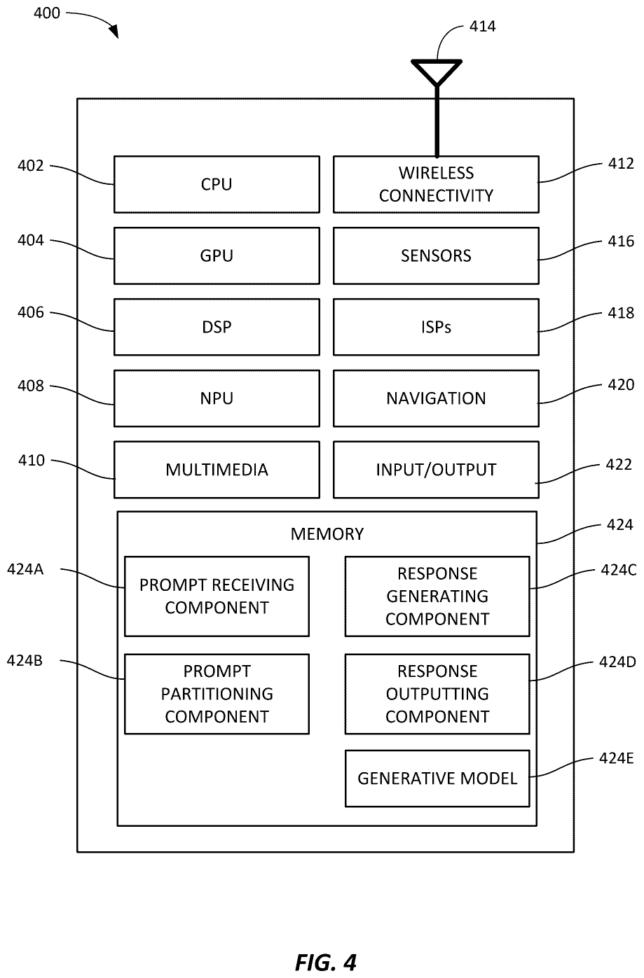

FIG. 4 depicts an example processing system 400 for processing large input prompts using generative artificial intelligence model, such as described herein for example with respect to FIGS. 1-3.

The processing system 400 includes a central processing unit (CPU) 402, which in some examples may be a multi-core CPU. Instructions executed at the CPU 402 may be loaded, for example, from a program memory associated with the CPU 402 or may be loaded from a memory partition (e.g., of a memory 424).

The processing system 400 also includes additional processing components tailored to specific functions, such as a graphics processing unit (GPU) 404, a digital signal processor (DSP) 406, a neural processing unit (NPU) 408, and a connectivity component 412.

An NPU, such as the NPU 408, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 408, are configured to accelerate the performance of common machine learning tasks, such as image classification, machine translation, object detection, and various other predictive models. In some examples, a plurality of NPUs may be instantiated on a single chip, such as a system on a chip (SoC), while in other examples such NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this new piece through an already trained model to generate a model output (e.g., an inference).

In some implementations, the NPU 408 is a part of one or more of the CPU 402, the GPU 404, and/or the DSP 406. These may be located on a user equipment (UE) in a wireless communication system or another computing device.

In some examples, the connectivity component 412 may include subcomponents, for example, for third generation (3G) connectivity, fourth generation (4G) connectivity (e.g., Long-Term Evolution (LTE)), fifth generation (5G) connectivity (e.g., New Radio (NR)), Wi-Fi connectivity, Bluetooth connectivity, and other wireless data transmission standards. The connectivity component 412 may be further coupled to one or more antennas 414.

The processing system 400 may also include one or more sensor processing units 416 associated with any manner of sensor, one or more image signal processors (ISPs) 418 associated with any manner of image sensor, and/or a navigation processor 420, which may include satellite-based positioning system components (e.g., GPS or GLONASS) as well as inertial positioning system components.

The processing system 400 may also include one or more input and/or output devices 422, such as screens, touch-sensitive surfaces (including touch-sensitive displays), physical buttons, speakers, microphones, and the like.

In some examples, one or more of the processors of the processing system 400 may be based on an ARM or RISC-V instruction set.

The processing system 400 also includes the memory 424, which is representative of one or more static and/or dynamic memories, such as a dynamic random access memory, a flash-based static memory, and the like. In this example, the memory 424 includes computer-executable components, which may be executed by one or more of the aforementioned processors of the processing system 400.

In particular, in this example, the memory 424 includes a prompt receiving component 424A, a prompt partitioning component 424B, a response generating component 424C, a response outputting component 424D, and a generative model 424E. The depicted components, and others not depicted, may be configured to perform various aspects of the methods described herein.

Generally, the processing system 400 and/or components thereof may be configured to perform the methods described herein.

### Example Clauses

Implementation details of various aspects of the present disclosure are described in the following numbered clauses.

Clause 1: A processor-implemented method for machine learning, comprising: receiving an input prompt for processing using a generative artificial intelligence model; partitioning the input prompt into a plurality of sub-prompts based on contextual information associated with tokens in the input prompt; generating a response to the input prompt using the generative artificial intelligence model based on the plurality of sub-prompts and contextual information associated with the tokens in the input prompt; and outputting the generated response.

Clause 2: The method of Clause 1, wherein: the contextual information comprises breadth metrics associated with the tokens in the input prompt; and partitioning the input prompt into the plurality of sub-prompts comprises: associating a respective breadth metric to a respective token from the tokens in the input prompt using a language model; and partitioning the tokens in the input prompt based on respective breadth metrics associated with respective tokens from the tokens in the input prompt.

Clause 3: The method of Clause 2, wherein the respective breadth metric comprises an indication of whether the respective token corresponds to a global concept in the input prompt or one or more local concepts in the input prompt.

Clause 4: The method of Clause 3, wherein partitioning the tokens in the input prompt comprises partitioning the tokens into a set of tokens corresponding to the global concept and one or more sets of tokens corresponding to the one or more local concepts in the input prompt.

Clause 5: The method of any of Clauses 1 through 4, wherein: the contextual information comprises temporal embeddings associated with the tokens in the input prompt; and partitioning the input prompt into the plurality of sub-prompts comprises partitioning the tokens in the input prompt into groups of temporally related tokens based on the temporal embeddings.

Clause 6: The method of any of Clauses 1 through 5, wherein the generative artificial intelligence model includes a gating mechanism configured to route the plurality of sub-prompts to different layers of the generative artificial intelligence model based on the contextual information associated with the tokens in the input prompt.

Clause 7: The method of Clause 6, wherein the gating mechanism comprises an attention layer in the generative artificial intelligence model, the attention layer comprising: a first projection block that projects the contextual information to key and value data; a second projection block that projects the tokens in the input prompt to query data; a multi-head attention block that generates an attention output based on the key data, the value data, and the query data; and a nonlinear layer that generates an attention mask based on the attention output, the attention mask being combined with the tokens in the input prompt to generate a masked set of tokens as an output of the gating mechanism.

Clause 8: The method of any of Clauses 1 through 7, wherein the generated response comprises an image depicting one or more objects specified by the input prompt.

Clause 9: The method of any of Clauses 1 through 8, wherein the generative artificial intelligence model comprises a text-to-image diffusion model configured to generate an image output from a textual input.

Clause 10: A processing system comprising: at least one memory having executable instructions stored thereon; and one or more processors coupled to the at least one memory and configured to execute the executable instructions in order to cause the processing system to perform the operations of any of Clauses 1 through 9.

Clause 11: A processing system comprising means for performing the operations of any of Clauses 1 through 9.

Clause 12: A non-transitory computer-readable medium having executable instructions stored thereon which, when executed by one or more processors, perform the operations of any of Clauses 1 through 9.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system, comprising:
at least one memory having executable instructions stored thereon; and
one or more processors coupled to the at least one memory and configured to execute the executable instructions in order to cause the processing system to:
receive an input prompt for processing using a generative artificial intelligence model;
partition the input prompt into a plurality of sub-prompts based on contextual information associated with tokens in the input prompt;
generate a response to the input prompt using the generative artificial intelligence model based on the plurality of sub-prompts and the contextual information associated with the tokens in the input prompt; and
output the generated response.

2. The processing system of claim 1, wherein:
the contextual information comprises breadth metrics associated with the tokens in the input prompt; and
to partition the input prompt into the plurality of sub-prompts, the one or more processors are configured to cause the processing system to:
associate a respective breadth metric to a respective token from the tokens in the input prompt using a language model; and
partition the tokens in the input prompt based on respective breadth metrics associated with respective tokens from the tokens in the input prompt.

3. The processing system of claim 2, wherein the respective breadth metric comprises an indication of whether the respective token corresponds to a global concept in the input prompt or one or more local concepts in the input prompt.

4. The processing system of claim 3, wherein to partition the tokens in the input prompt, the one or more processors are configured to cause the processing system to partition the tokens into a set of tokens corresponding to the global concept and one or more sets of tokens corresponding to the one or more local concepts in the input prompt.

5. The processing system of claim 1, wherein:
the contextual information comprises temporal embeddings associated with the tokens in the input prompt; and
to partition the input prompt into the plurality of sub-prompts, the one or more processors are configured to cause the processing system to partition the tokens in the input prompt into groups of temporally related tokens based on the temporal embeddings.

6. The processing system of claim 1, wherein the generative artificial intelligence model includes a gating mechanism configured to route the plurality of sub-prompts to different layers of the generative artificial intelligence model based on the contextual information associated with the tokens in the input prompt.

7. The processing system of claim 6, wherein the gating mechanism comprises an attention layer in the generative artificial intelligence model, the attention layer comprising:
a first projection block that projects the contextual information to key data and value data;
a second projection block that projects the tokens in the input prompt to query data;
a multi-head attention block that generates an attention output based on the key data, the value data, and the query data; and
a nonlinear layer that generates an attention mask based on the attention output, the attention mask being combined with the tokens in the input prompt to generate a masked set of tokens as an output of the gating mechanism.

8. The processing system of claim 1, wherein the generated response comprises an image depicting one or more objects specified by the input prompt.

9. The processing system of claim 1, wherein the generative artificial intelligence model comprises a text-to-image diffusion model configured to generate an image output from a textual input.

10. A processor-implemented method for machine learning, comprising:
receiving an input prompt for processing using a generative artificial intelligence model;
partitioning the input prompt into a plurality of sub-prompts based on contextual information associated with tokens in the input prompt;
generating a response to the input prompt using the generative artificial intelligence model based on the plurality of sub-prompts and the contextual information associated with the tokens in the input prompt; and
outputting the generated response.

11. The method of claim 10, wherein:
the contextual information comprises breadth metrics associated with the tokens in the input prompt; and
partitioning the input prompt into the plurality of sub-prompts comprises:
associating a respective breadth metric to a respective token from the tokens in the input prompt using a language model; and
partitioning the tokens in the input prompt based on respective breadth metrics associated with respective tokens from the tokens in the input prompt.

12. The method of claim 11, wherein the respective breadth metric comprises an indication of whether the respective token corresponds to a global concept in the input prompt or one or more local concepts in the input prompt.

13. The method of claim 12, wherein partitioning the tokens in the input prompt comprises partitioning the tokens into a set of tokens corresponding to the global concept and one or more sets of tokens corresponding to the one or more local concepts in the input prompt.

14. The method of claim 10, wherein:
the contextual information comprises temporal embeddings associated with the tokens in the input prompt; and
partitioning the input prompt into the plurality of sub-prompts comprises partitioning the tokens in the input prompt into groups of temporally related tokens based on the temporal embeddings.

15. The method of claim 10, wherein the generative artificial intelligence model includes a gating mechanism configured to route the plurality of sub-prompts to different layers of the generative artificial intelligence model based on the contextual information associated with the tokens in the input prompt.

16. The method of claim 15, wherein the gating mechanism comprises an attention layer in the generative artificial intelligence model, the attention layer comprising:
a first projection block that projects the contextual information to key data and value data;
a second projection block that projects the tokens in the input prompt to query data;
a multi-head attention block that generates an attention output based on the key data, the value data, and the query data; and
a nonlinear layer that generates an attention mask based on the attention output, the attention mask being combined with the tokens in the input prompt to generate a masked set of tokens as an output of the gating mechanism.

17. The method of claim 10, wherein the generated response comprises an image depicting one or more objects specified by the input prompt.

18. The method of claim 10, wherein the generative artificial intelligence model comprises a text-to-image diffusion model configured to generate an image output from a textual input.

19. A processing system, comprising:
means for receiving an input prompt for processing using a generative artificial intelligence model;
means for partitioning the input prompt into a plurality of sub-prompts based on contextual information associated with tokens in the input prompt;
means for generating a response to the input prompt using the generative artificial intelligence model based on the plurality of sub-prompts and the contextual information associated with the tokens in the input prompt; and
means for outputting the generated response.
